(19) United States
(12) Patent Application Publication
(10) Pub. No.: US 2011/0008653 A1
(43) Pub. Date: Jan. 13, 2011

(54) POLYMER BATTERY PACK

(75) Inventors: Jongwook YOON, Suwon-si (KR); Woonseong Baek, Suwon-si (KR); Sangjoo Lee, Suwon-si (KR)

Correspondence Address: KNOBBE MARTENS OLSON & BEAR LLP, 2040 MAIN STREET, FOURTEENTH FLOOR, IRVINE, CA, 92614, US

(73) Assignee: Samsung SDI Co., Ltd., Suwon-si (KR)

(21) Appl. No.: 12/831,291

(22) Filed: Jul. 7, 2010

(30) Foreign Application Priority Data
Jul. 10, 2009 (KR) 10-2009-0063213

(51) Int. Cl. H01M 14/00; H01M 2/02

(52) U.S. Cl. 429/7; 429/163

(57) ABSTRACT

A polymer battery pack including: a polymer bare cell; a frame surrounding the polymer bare cell and having protrusions formed on a top thereof; and a case positioned on the top of the frame and having grooves formed on a bottom thereof to correspond to the protrusions. The protrusions and the grooves are coupled to each other.

### CROSS-REFERENCE TO RELATED APPLICATION

This application claims the benefit of Korean Patent Application No. 10-2009-0063213, filed on Jul. 10, 2009 in the Korea Intellectual Property Office, the disclosure of which is incorporated herein by reference.

### BACKGROUND OF THE INVENTION

1. Field of the Invention

Aspects of the present invention relate to a polymer battery pack.

2. Description of the Related Art

A polymer battery pack includes a bare cell having an electrode assembly and a pouch surrounding the electrode assembly, and a protective circuit module. A frame may be further installed in the polymer pack. The bare cell and the protective circuit module may be positioned in the frame. Alternatively, the bare cell may be positioned in the frame while the protective module is positioned on top of the frame. In the former, the protective circuit module is protected by the top of the frame so that a case is not necessary. In the latter, however, the protective circuit module is exposed to an outside so that a case is formed on the protective module to pack a battery pack.

### SUMMARY OF THE INVENTION

Aspects of the present invention provide a polymer battery pack that has an improved assembly strength by improving a coupling force between a frame and a case.

According to an aspect of the present invention, there is provided a polymer battery pack including: a polymer bare cell; a frame surrounding the bare cell and having protrusions on a top thereof; and a case positioned on the top of the frame and having a groove formed on a bottom thereof to correspond to the protrusions, wherein the protrusions and the grooves are coupled to each other.

The frame may include: a first sub-frame and a second sub-frame respectively surrounding both narrow sides of the polymer bare cell; a third sub-frame surrounding a top of the polymer bare cell; and a fourth sub-frame surrounding a bottom of the polymer bare cell.

The protrusions may be respectively positioned on tops of the first and second sub-frames or on opposite ends of a top of the third sub-frame.

A protective circuit module may be positioned between the frame and the case.

The frame may include a first sub-frame and a second sub-frame surrounding both narrow sides of the polymer bare cell and a third sub-frame surrounding the bottom of the polymer bare cell, and may have a staple shape.

The protrusions may be respectively positioned on the top of the first and the second sub-frames.

A protective circuit module may be positioned between the top of the polymer bare cell and the case.

The protrusions may be press-fitted into the grooves and/or coupled with the grooves by coating adhesive on the protrusions or the grooves.

The protrusions and the grooves may have a polygonal, a circular, and/or a minus shape.

According to another aspect of the present invention, there is provided a polymer battery pack including: a polymer bare cell; a frame surrounding the polymer bare cell and having grooves formed in a top thereof; and a case positioned on the frame and having protrusions formed on a bottom thereof to correspond to the grooves, wherein the protrusions and the grooves are coupled to each other.

According to aspects of the present invention, a polymer battery pack having protrusions formed on a top of a frame and respectively coupled to grooves formed in a bottom of a case increases an assembly strength of the polymer battery pack.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is an exploded perspective view illustrating a polymer battery pack according to an embodiment of the present invention;

FIG. 2 is a detailed view illustrating a frame and a case of the polymer battery pack according to an embodiment of the present invention;

FIG. 3 is an exploded perspective view illustrating a polymer battery pack according to another embodiment of the present invention; and

FIG. 4 is a detailed view illustrating a frame and a case of the polymer battery pack according to another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

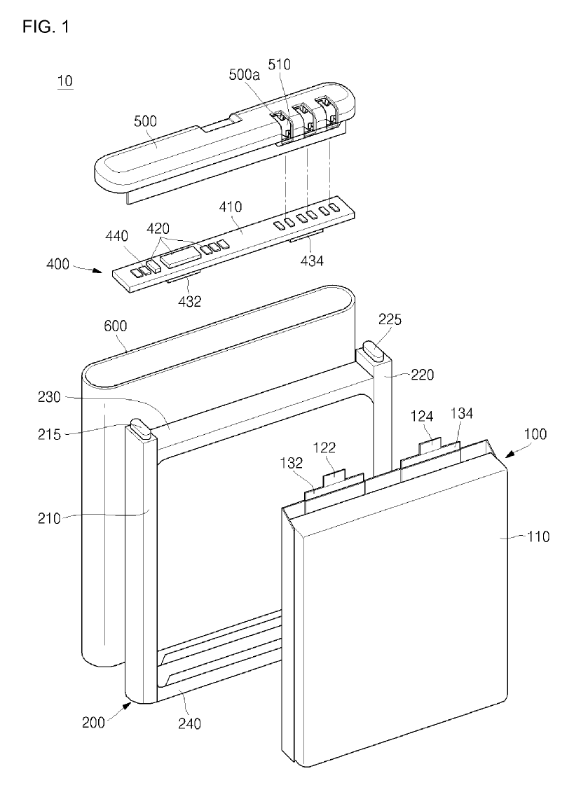

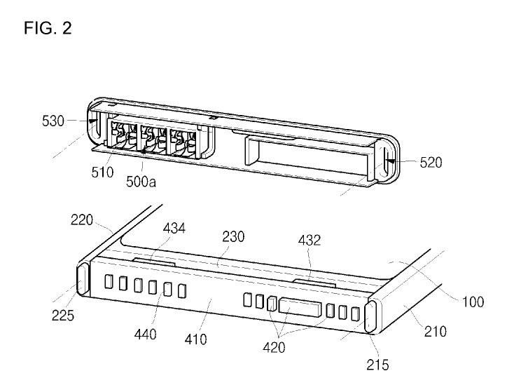

Hereinafter, a polymer battery pack according to various embodiments of the present invention will be described in detail with reference to accompanying drawings. FIG. 1 is an exploded perspective view illustrating a polymer battery pack 10 according to an embodiment of the present invention, and FIG. 2 is a detailed view illustrating a frame 200 and a case 500 of the polymer battery pack 10 according to the embodiment of the present invention. Referring to FIGS. 1 and 2, the polymer battery pack 10 includes a bare cell 100, the frame 200, a protective circuit module 400, the case 500, and a label 600. Protrusions 215 and 225 formed on the top of the frame 200 and grooves 520 and 530 formed in the bottom of the case 500 increase an assembly strength of the polymer battery pack 10.

The bare cell 100 includes an electrode assembly (not shown) and a pouch 110 accommodating the electrode assembly. The electrode assembly is fabricated by winding a first electrode plate (not shown), a second electrode plate (not shown), and a separator (not shown) interposed between the first electrode plate and the second electrode plate into a jelly-roll type. The electrode assembly may be sealed together with an electrolyte by the pouch 110. A first electrode tab 122 is formed on a side of the first electrode plate of the electrode assembly, and a second electrode tab 124 is formed on a side of the second electrode plate. The first electrode tab 122 and the second electrode tab 124 are arranged in parallel to maintain a preset gap in the jelly-roll type. Parts of the first electrode tab 122 and the second electrode tab 124 are exposed to an outside of the pouch 110 such that the electrode assembly is electrically connected to the protective circuit module 400. The first electrode tab 122 and the second electrode tab 124 may be made of metal, such as aluminum, copper, or nickel.

A first insulation tape 132 and a second insulation tape 134 are interposed between the first and second electrode tabs 122 and 124 and the pouch 110. The first insulation tape 132 and the second insulation tape 134 are attached to regions on which the first electrode tab 122 and the second electrode tab 124 contact the pouch 110 so that a short between the first and second electrode tabs 122 and 124 and the pouch 110 may be prevented. Hereinafter, a case where the first electrode plate and the first electrode tab 122 serve as a positive electrode, and the second electrode plate and the second electrode tab 124 serve as a negative electrode will be described, though it is understood that all embodiments of the present invention are not limited thereto.

The pouch 110 is integrally formed to have an approximately polygonal shape, and may be folded about a longitudinal direction along narrow sides thereof. A recess into which the electrode assembly is accommodated is formed in the center of the pouch 110 by pressing. The pouch 110 may have a triple layer structure having a nylon layer, an aluminum thin layer, and a resin layer made of a polyolefin.

The frame 200 may have a square shape surrounding a top, bottom, and two sides of the bare cell 100. In more detail, the frame 200 includes a first sub-frame 210 and a second sub-frame 220 respectively surrounding narrow sides of the polymer bare cell 100, a third sub-frame 230 surrounding the top of the polymer bare cell 100, and a fourth sub-frame 240 surrounding the bottom of the polymer bare cell 100. The first and second sub-frames 210 and 220 are connected to respective sides of the third and fourth sub-frames 230 and 240 so that the frame 200 may have a square shape. The bare cell 100 is disposed inside of the frame 200, and the electrode tabs 122 and 124 on the top of the bare cell 100 may protrude to an outside of the third sub-frame 230. Ends of the first and second sub-frames 210 and 220 may protrude higher in the direction of the top of the bare cell 100 than the top of the third sub-frame 230. The protrusions 215 and 225 are respectively formed on the tops of the first and second sub-frames 210 and 220.

The protective circuit module 400 is positioned on the top of the third sub-frame 230 to be electrically connected to the bare cell 100. Moreover, the protective circuit module 400 includes a protective circuit board 410, a protective circuit element 420, a first lead plate 432, a second lead plate 434, and charge-discharge terminals 440. The protective circuit module 400 may further include a positive temperature coefficient (PTC) element (not shown).

The protective circuit board 410 is positioned on the third sub-frame 230 and may be a square shaped plate. The protective circuit board 410 has conductive metal patterns (not shown) to electrically connect the protective circuit element 420, the first lead plate 432, the second lead plate 434, and the charge-discharge terminals 440.

The protective circuit element 420 is mounted on the top of the protective circuit board 410, and protects the polymer battery pack 10 from overcharge and overdischarge by monitoring information about charge-discharge states of the bare cell 100 and information about the battery (such as current, voltage, and temperature).

The first and second lead plates 432 and 434 may be formed on the bottom of the protective circuit board 410 to respectively correspond to the first and second electrode tabs 122 and 124. The first and second lead plates 432 and 434 are respectively welded to the first and second electrode plates 432 and 434, and the third sub-frame 230 and the protective circuit board 410 are bent to be parallel with each other such that the protective circuit module 400 may be seated on the third sub-frame 230. The charge-discharge terminals 440 are positioned on the top of the protective circuit board 410, and serve as an electrical passage to supply power to an external electronic device.

The case 500 is positioned on the protective circuit module 400 to protect the protective circuit module 400 from external shock. Charge-discharge terminal holes 500a are formed at positions of the case 500 corresponding to the charge-discharge terminals 440. Spring terminals 510 electrically connected the charge-discharge terminals 440 may be positioned in the charge-discharge terminal holes 500a. The polymer battery pack 10 supplies electric power to an external electronic device and/or is supplied with electric power from an outside through the spring terminal 510 in the charge-discharge terminal holes 500a. On the bottom of the case 500, the grooves 520 and 530, which are coupled with the protrusions 215 and 225 of the frame 200, are formed at positions respectively corresponding to the protrusions 215 and 225 of the frame 200.

The label 600 is positioned to surround the bare cell 100 and the frame 200, and protects the bare cell 100 from external shock or scratches.

Hereinafter, the protrusions 215 and 225 of the frame 200 and the grooves 520 and 530 of the case will be described in detail. The protrusions 215 and 225 are positioned on a top surface of the first sub-frame 210 and the second sub-frame 220, respectively. While in the current embodiment, the protrusions 215 and 225 have a minus shape with curvatures on sides facing the wide sides of the protective circuit board 410, it is understood that all embodiments are not limited thereto. For example, the protrusions 215 and 225 may have a polygonal shape such as a square, a rectangular, and the like, or a circular shape. The shapes of the protrusions 215 and 225 as described above are the shapes when viewing from the top. It is understood that reference to “top,” “bottom,” and “sides” in the present disclosure are non-limiting relative terms used in relation to the battery pack 10 as illustrated in FIG. 1 in order to describe aspects of the present invention more easily.

The grooves 520 and 530 to be coupled to the protrusions 215 and 225, respectively, are formed on the bottom of the case 500 to correspond to the protrusions 215 and 225, respectively. When the bare cell 100, the frame 200, and the protective circuit module 400 are coupled to each other, the case 500 is coupled to the top of the protective circuit module 400. In more detail, since the protrusions 215 and 225 and the grooves 520, 530 are press-fitted to each other, a coupling strength between the frame 200 and the case 500 increases, so that an assembly strength of the battery pack 10 is improved.

Moreover, before the case 500 and the frame 200 are coupled to each other, an adhesive may be coated on the protrusions 215 and 225 and/or the grooves 520 and 530. Accordingly, the case 500 and the frame 200 are coupled to each other with an improved coupling strength therebetween.

Ends of the first sub-frame 210 and the second sub-frame 220, which face the top of the bare cell 100, may protrude over the top of the third sub-frame 230. In this case, since the protective circuit module 400 may be seated in an empty space defined by the tops of the first and second sub-frames 210 and 220, and the third sub-frame 230, the protective circuit module 400 may be more stably packed.

While in the present embodiment, the ends of the first sub-frame 210 and the second sub-frame 220 protrude over the top of the third sub-frame 230, it is understood that all embodiments are not limited thereto. For example, the tops of the first sub-frame 210 and the second sub-frame 220 may be positioned on the bottom of the bare cell 100, or no part of the first sub-frame 210 and the second sub-frame 220 may project beyond the third sub-frame 230 and the fourth sub-frame 240. In this case, the protrusions 215 and 225 are positioned at both sides of the third sub-frame 230 and the case 500 is coupled with the protrusions 215 and 225 on the top of the third sub-frame 230 so that the coupling strength between the frame 200 and the case 500 is increased and the assembly strength of the battery pack is improved.

Furthermore, in the above-described structures, the protrusions 215 and 225 and the grooves 520 and 530 may be formed at opposite positions. That is, the protrusions 215 and 225 may be formed on both sides of the bottom of the case 500 and the grooves 520 and 530 may be formed in the top of the frame 200 to correspond to the protrusions 215 and 225. When the ends of the first sub-frame 210 and the second sub-frame 220, which face the top of the bare cell 100, protrude over the top of the third sub-frame 230, the grooves may be formed in the top of the first sub-frame 210 and the second sub-frame 220, respectively. When the tops of the first sub-frame 210 and the second sub-frame 220 are positioned on the bottom of the bare cell 100 or when no part of the first sub-frame 210 and the second sub-frame 220 projects beyond the third sub-frame 230 and the fourth sub-frame 240, the grooves 520 and 530 may be positioned at both sides of the third sub-frame 230, respectively.

Hereinafter, a polymer battery pack 20 according to another embodiment of the present invention will be described in detail. The polymer battery pack 20 according to another embodiment of the present invention has a frame structure different from that of the polymer battery pack 10 according to the embodiment of the present invention described above with reference to FIGS. 1-2. Therefore, the coupling structure of the bare cell 100, the frame 300, and the protective circuit module 400 is different from that of the above-mentioned embodiment. Hereinafter, the differences will be mainly described and descriptions of same elements and functions will be omitted.

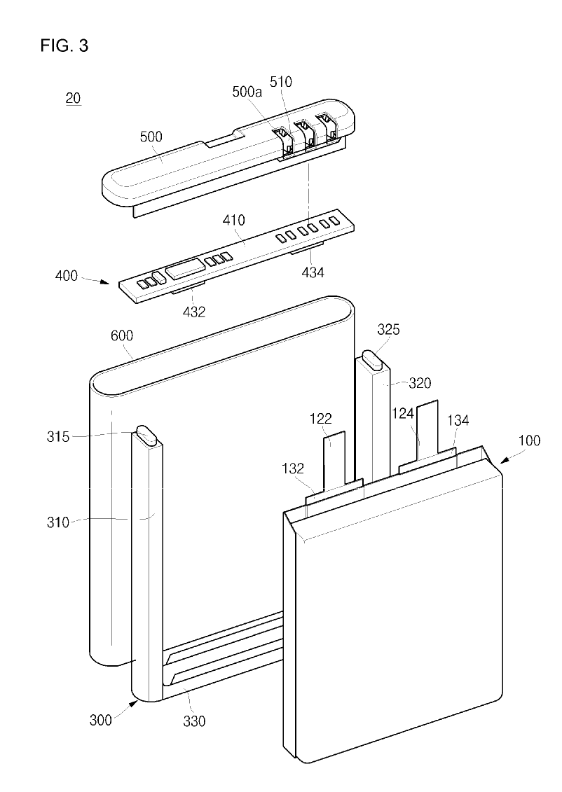

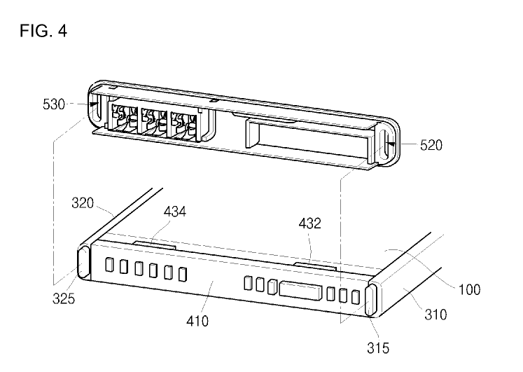

FIG. 3 is an exploded perspective view illustrating a polymer battery pack 20 according to another embodiment of the present invention, and FIG. 4 is a detailed view illustrating a frame 300 and a case 500 of the polymer battery pack 20 according to another embodiment of the present invention. Referring to FIGS. 3 and 4, the frame 300 of the polymer battery pack 20 has a structure surrounding the bottom and both narrow sides of the bare cell 100. In more detail, the frame 300 includes a first sub-frame 310 and a second sub-frame 320 surrounding the narrow sides of the bare cell 100, and a third sub-frame 330 surrounding the bottom of the bare cell 100. The bottoms of the first sub-frame 310 and the second sub-frame 320 are respectively connected to both sides of the third sub-frame 330, and the frame 300 may have a staple shape. The bare cell 100 is disposed inside of the frame 300 such that the narrow sides and the bottom of the bare cell 300 may contact the inner surfaces of the first sub-frame 310, the second sub-frame 320, and the third sub-frame 330, respectively. Protrusions 315 and 325 may be formed on the tops of the first sub-frame 310 and the second sub-frame 320, respectively.

A protective circuit module 400 is positioned on the top of the bare cell 300 to be electrically connected to the bare cell 300. In more detail, a first electrode tab 122 and a second electrode tab 124 are respectively welded to a first lead plate 432 and a second lead plate 434 and are bent such that the top of the bare cell 300 and a protective circuit board 410 are parallel with each other so that the protective circuit module 400 may be seated on the top of the bare cell 300.

The case 500 includes grooves 520 and 530 that are respectively coupled to the protrusions 315 and 325 of the frame at positions corresponding to the protrusions 315 and 325 of the frame. The protrusions 315 and 325 may be positioned on the tops of the first sub-frame 310 and the second sub-frame 320, respectively. While the protrusions 315 and 325 have a minus shape with curvatures on sides facing the wide sides of the protective circuit board 410 in FIGS. 3 and 4, it is understood that all embodiments are not limited thereto. For example, the protrusions 315 and 325 may have a polygonal shape such as a square, a rectangular, and the like, or a circular shape. The shapes of the protrusions 315 and 325 are the shapes when viewing from the top. It is understood that reference to “top,” “bottom,” and “sides” in the present disclosure are non-limiting relative terms used in relation to the battery pack 20 as illustrated in FIG. 3 in order to describe aspects of the present invention more easily.

The grooves 520 and 530, which are coupled to the protrusions 315 and 325, are formed on the bottom of the case 500 to correspond to the protrusions 315 and 325, respectively. When the bare cell 100, the frame 300, and the protective circuit module 400 are couple to each other, the case 500 may be coupled to the top of the protective circuit module 400. In more detail, since the protrusions 315 and 325 and the grooves 520 and 530 are press-fitted to each other, a coupling strength between the frame 300 and the case 500 increases, so that an assembly strength of the battery pack 20 improves. Moreover, before the case 500 and the frame 300 are coupled to each other, an adhesive may be coated on the protrusions 315 and 325 and/or the grooves 520 and 530. Then, the case 500 and the frame 300 are coupled to each other so that coupling strength therebetween improves.

The frame 300 of the polymer battery pack 20 does not include a sub-frame formed at a position corresponding to the top of the bare cell 100. Accordingly, manufacturing costs may be reduced. Furthermore, since the manufacturing process of coupling the bare cell 100 to the frame 300 having an opened side is easier than the manufacturing process of coupling the bare cell to the polygonal frame 200, a process efficiency may be enhanced.

In the above-mentioned structures, the protrusions 315 and 325 and the grooves 520 and 530 may be formed at opposite positions. That is, the protrusions 315 and 325 may be formed on both sides of the bottom of the case 500 and the grooves 520 and 530 may be formed in the top of the frame 200 to correspond to the protrusions 315 and 325. In this case, the grooves 520 and 530 may be formed in the tops of the first sub-frame 310 and the second sub-frame 320, respectively.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A polymer battery pack comprising:
a polymer bare cell;
a frame surrounding the polymer bare cell and having protrusions formed on a top thereof; and
a case positioned on the top of the frame and having grooves formed on a bottom thereof respectively corresponding to the protrusions,
wherein the protrusions and the grooves are coupled to each other.

2. The polymer battery pack as claimed in claim 1, wherein the frame comprises:
a first sub-frame and a second sub-frame surrounding a first narrow side and a second narrow side of the polymer bare cell, respectively;
a third sub-frame surrounding a top of the polymer bare cell; and
a fourth sub-frame surrounding a bottom of the polymer bare cell.

3. The polymer battery pack as claimed in claim 2, wherein the protrusions are positioned on respective tops of the first and second sub-frames facing the case.

4. The polymer battery pack as claimed in claim 2, wherein the protrusions are respectively positioned on opposite ends of a top of the third sub-frame.

5. The polymer battery pack as claimed in claim 1, further comprising a protective circuit module between the frame and the case.

6. The polymer battery pack as claimed in claim 1, wherein the frame comprises:
a first sub-frame and a second sub-frame surrounding a first narrow side and a second narrow side of the polymer bare cell, respectively; and
a third sub-frame surrounding a bottom of the polymer bare cell.

7. The polymer battery pack as claimed in claim 6, wherein the protrusions are positioned on respective tops of the first and the second sub-frames facing the case.

8. The polymer battery pack as claimed in claim 6, further comprising a protective circuit module between a top of the polymer bare cell and the case.

9. The polymer battery pack as claimed in claim 1, wherein the protrusions are press-fitted into the grooves.

10. The polymer battery pack as claimed in claim 1, wherein the protrusions and the grooves have a polygonal shape, a circular shape, and/or a minus shape.

11. The polymer battery pack as claimed in claim 1, further comprising a label surrounding the frame.

12. The polymer battery pack as claimed in claim 1, wherein the protrusions and/or the grooves are coated with an adhesive.

13. The polymer battery pack as claimed in claim 2, wherein respective tops of the first sub-frame and the second sub-frame extend beyond a top of the third sub-frame.

14. A polymer battery pack comprising:
a polymer bare cell;
a frame surrounding the polymer bare cell and having grooves formed in a top thereof; and
a case positioned on the top of the frame and having protrusions formed on a bottom thereof respectively corresponding to the grooves,
wherein the protrusions and the grooves are coupled to each other.

15. The polymer battery pack as claimed in claim 14, wherein the frame comprises:
a first sub-frame and a second sub-frame surrounding a first narrow side and a second narrow side of the polymer bare cell respectively, respectively;
a third sub-frame surrounding a top of the polymer bare cell; and
a fourth sub-frame surrounding a bottom of the polymer bare cell.

16. The polymer battery pack as claimed in claim 15, wherein the grooves are positioned on respective tops of the first and second sub-frames facing the case.

17. The polymer battery pack as claimed in claim 15, wherein the grooves are respectively positioned on opposite ends of a top of the third sub-frame.

18. The polymer battery pack as claimed in claim 14, wherein the frame comprises:
a first sub-frame and a second sub-frame surrounding a first narrow side and a second narrow side of the polymer bare cell, respectively; and
a third sub-frame surrounding the bottom of the polymer bare cell.

19. The polymer battery pack as claimed in claim 18, wherein the grooves are positioned on respective tops of the first and the second sub-frames facing the case.

20. The polymer battery pack as claimed in claim 14, wherein the protrusions are press-fitted into the grooves.

21. The polymer battery pack as claimed in claim 14, wherein the protrusions and/or the grooves are coated with an adhesive.

22. A frame to surround a polymer bare cell of a polymer battery pack including a protective circuit module on a top of the frame and a case to cover the protective circuit module, the frame comprising:
a first sub-frame and a second sub-frame surrounding a first narrow side and a second narrow side of the polymer bare cell, respectively;
a third sub-frame surrounding a top of the polymer bare cell; and
a fourth sub-frame surrounding a bottom of the polymer bare cell,
wherein protrusions or grooves are respectively positioned on opposite ends of a top of the third sub-frame, and
the protrusions or grooves are respectively coupled to corresponding grooves or protrusions on a bottom of the case.

23. The frame as claimed in claim 22, wherein the protrusions or grooves respectively positioned on opposite ends of the top of the third sub-frame are respectively press-fitted into the corresponding grooves or positions on the bottom of the case.

24. A frame to surround a polymer bare cell of a polymer battery pack including a protective circuit module on a top of the frame and a case to cover the protective circuit module, the frame comprising:
a first sub-frame and a second sub-frame surrounding a first narrow side and a second narrow side of the polymer bare cell, respectively; and
a third sub-frame surrounding a bottom of the polymer bare cell,
wherein protrusions or grooves are positioned on respective tops of the first and second sub-frames, and
the protrusions or grooves are respectively coupled to corresponding grooves or protrusions on a bottom of the case.

25. The frame as claimed in claim 24, further comprising a fourth sub-frame surrounding a top of the polymer bare cell.

26. The frame as claimed in claim 24, wherein the protrusions or grooves positioned on respective tops of the first and second sub-frames are respectively press-fitted into the corresponding grooves or positions on the bottom of the case.
